(19) United States
(12) Patent Application Publication
(10) Pub. No.: US 2024/0145848 A1
(43) Pub. Date: May 2, 2024

(54) Pressure equalization device

(71) Applicant: BODO KONZELMANN KG, Löchgau (DE)

(72) Inventors: Andre’ Konzelmann, Bietigheim-Bissingen (DE); Volker Buchmann, Rutesheim (DE)

(21) Appl. No.: 18/279,620

(22) PCT Filed: Sep. 10, 2021
(86) PCT No.: PCT/EP2021/074888

§ 371 Date: Sep. 1, 2023

(30) Foreign Application Priority Data
Mar. 19, 2021 (DE) 10 2021 106 903.3

(51) Int. Cl. H01M 50/342; F16K 17/04; F16K 17/16; H01M 50/30

(52) U.S. Cl. CPC H01M 50/3425; F16K 17/0453; F16K 17/16; H01M 50/394

(57) ABSTRACT

The invention relates to a pressure equalization device (10) for equalizing an internal pressure in a receiving housing of an electrochemical or electrical device, in particular for a battery housing, having a housing (20), which has at least one gas passage opening (26.2), wherein the gas passage opening (26.2) is blocked by means of a gas-tight, in particular air-tight, diaphragm (30), which is held in or on a diaphragm mount (26) in the housing (20), and wherein a cutting element (30) is assigned to the gas-tight diaphragm (50), which cutting element is designed and positioned in such a way that, in the event of a deformation of the gas-tight diaphragm (50), the cutting element (30) destroys the diaphragm (50) at least at one location to establish a flow connection between an interior (21.2) of the pressure equalization device (10) and an exterior (21.1) of the pressure equalization device (10) through the gas passage opening (26.2). In order to be able to implement reliable functionality in such a pressure equalization device (10), provision is made in accordance with the invention for the cutting element (30) to be coupled indirectly or directly to the housing (20) by means of a spring section (31) in such a way that, in the event of deformation of the diaphragm (50), the cutting element is displaced at least sectionally.

The invention relates to a pressure equalization device for equalizing an internal pressure in a receiving housing of an electrochemical or electrical device, in particular for a battery housing, having a housing, which comprises at least one gas passage opening, wherein the gas passage opening is closed off by means of a gas-permeable or gas-tight diaphragm, which is held in or on a diaphragm mount in the housing, and wherein a cutting element is assigned to the diaphragm, which cutting element is designed and positioned in such a way that, in the event of a deformation of the diaphragm, the cutting element destroys the diaphragm at least at one point to establish a flow connection between an interior of the pressure equalization device and an exterior of the pressure equalization device via the gas passage opening.

Such a pressure equalization device is known from DE 10 2011 080 325 A1. This known pressure equalization device features a support element having a flange section with drilled holes for attachment to a battery housing. In so doing, the support element covers the rim of an aperture in the battery housing. The support element is connected to a diaphragm that blocks a gas passage opening of the support element. The diaphragm is stretched between the support element and a clamping piece and is held in a circumferentially sealed manner. Further, a housing-like protective element is used, which comprises a cutting element in a central area. This cutting element is opposite from the diaphragm. The protective element is used to prevent access to the diaphragm from the exterior of the pressure equalization device. The protective element has gas passage openings. The diaphragm is gas permeable but essentially water repellent. The water-repellent function is such that water from the environment cannot reach the interior from the exterior, or only to an insignificant extent. During normal operation, the diaphragm can provide the gas equalization between the environment and the battery housing. This is possible because the diaphragm is permeable to gas. If an abrupt burst pressure now occurs, for instance due to a fault in the battery housing, the diaphragm bulges outward. A distance is provided between the cutting element and the outer face of the diaphragm, which determines the permissible deformation of the diaphragm in such a damage event. If the diaphragm bulges beyond the permissible deformation, it hits the cutting element, which is designed as a tip. The cutting element damages the diaphragm, causing it to tear. The gas can then quickly escape from the battery housing through the gas passage opening into the environment. This prevents the battery case from exploding.

The pressure equalization device known from the prior art has a complex design. In addition, owing to the inevitable dimensional tolerances that occur between the individual components of the device same design, it cannot be ensured that the cutting element is always at exactly the same distance from the surface of the diaphragm in different emergency degassing devices of the same type. Therefore, there is no exactly reproducible bursting behavior in case of overload.

The invention addresses the problem of providing a robust pressure equalization device of the type mentioned above, which ensures a reproducible bursting behavior using little assembly effort and few parts.

This problem is solved in that the cutting element is coupled directly or indirectly to the housing by means of a spring section in such a way that the cutting element is displaced at least sectionally when the diaphragm is deformed. According to the invention, the spring behavior of the spring section ensures the reproducible bursting behavior. In particular, for instance, the spring section can be used to set a spring characteristic or a spring characteristic results from the spring section. As the deformation of the diaphragm increases, the counterforce on the diaphragm provided via the spring section also increases. The spring force of the spring section is transferred to the cutting element and is thus applied to a blade of the cutting element. From a certain displacement path of the cutting element, the spring force then becomes so high that the blade cuts the diaphragm, which then releases the gas passage opening.

To be able to ensure a defined deflection process for the cutting element, provision may be made for the cutting element to have a deflection piece indirectly or directly adjacent to the cutting element, which deflection piece bears against the diaphragm at least in one operating position of the diaphragm.

In particular, provision may be made for the deflection piece to bear against the diaphragm, in particular across its surface, in the non-pressurized basic position of the diaphragm, in particular when the same ambient pressure is present in the area of the interior and the exterior. In this case, the deflection piece is already precisely assigned to the diaphragm in the basic position, resulting in a particularly reproducible bursting behavior.

Surprisingly, particularly good functionality for the cutting element results if provision is made for the deflection piece and/or the spring section of the cutting element to be connected to the diaphragm, in particular positively to the diaphragm, at least sectionally.

However, to reduce the assembly effort and number of parts, provision may also be made for the cutting element to be integrally connected to the housing.

To implement a pressure equalization device of space-saving design, provision may be made for the gas passage opening to be delimited by an inner panel of the housing, wherein preferably provision is made for the inner panel to be of circumferential design, and for the cutting element to project from the inner panel in the direction of the gas passage opening and to preferably project from the inner panel in the form of a tongue.

A pressure equalization device according to the invention can be such that the cutting element has rims on opposite sides, which laterally delimit the cutting element, and that the cutting element adjoins the rims directly or indirectly, spaced apart from the inner panel. If, in addition, provision may be made for the rims to preferably converge in the direction from the inner panel to the free end of the cutting element, at least sectionally, then a defined cutting element can be created in a simple manner in the area of the converging end sections of the rims. In the context of the invention, a rim or rims may also each have or form at least one cutting element.

According to the invention, however, provision may be made for at least the free end of the cutting element and/or the rims and/or another area of the cutting element to be arranged spaced apart from the inner panel of the housing to have or form a blade.

According to the invention, provision may also be made for the housing to comprise a diaphragm mount having a connection section, and for the diaphragm to be circumferentially connected to the connection section by an mounting section. This results in a simple design. In particular, provision may also be made for the diaphragm to be back-injected with the housing in a plastic-injection-molding process. Accordingly, the connection and sealing of the diaphragm to the housing is integrated into the injection molding process. However, within the scope of the invention, it is also possible for the diaphragm to be joined to a manufactured housing, in particular to be joined by an adhesive bond. Within the scope of the invention, preferably provision may be made for the contact section to transition into the connection section in a planar manner. This allows the diaphragm to be precisely fitted to the contact section. It is particularly advantageous if the contact section merges seamlessly into the connection section, i.e., these two component areas form a uniform surface

One conceivable variant of the invention is such that the diaphragm has an outer face of the diaphragm and, opposite thereto, an inner face of the diaphragm, that the outer face of the diaphragm faces the exterior of the housing and the inner face of the diaphragm faces the interior of the housing, and that the cutting element is opposite from the outer face of the diaphragm, in particular rests on the latter in the non-pressurized basic position of the diaphragm.

According to a possible variant of the invention, provision may be made for a travel limiter to be provided, which holds a stop spaced apart from the cutting element in the direction towards the exterior of the housing, and for the cutting element to strike against the stop when the diaphragm is deformed. In this case, the design of the pressure equalization device can in particular be such that the diaphragm deforms during operation. The deformation of the diaphragm also enables the cutting element to be displaced. As described above, the cutting element moves against the force of the spring section. This makes it possible to implement a spring characteristic with a corresponding force effect on the blade of the cutting element. As soon as the cutting element hits the stop, a steep increase in the force acting on the blade of the cutting element is generated in the force-spring diagram and subsequently the cutting element is used to destroy the diaphragm when an unacceptably high pressure is reached. In this way, a reproducible bursting behavior can be set in a reliable manner.

This results in a simple design using little assembly effort and few parts if the travel limiter is integrally connected to the housing by means of a connection section.

Furthermore, a compact design can be implemented in that the stop of the travel limiter is kept spaced apart from the inner panel of the housing, which at least sectionally forms the gas passage opening, by means of a spacer.

One conceivable variant of the invention is such that the housing has a sealing section with a circumferential seal and/or an energy director, wherein the seal and/or the energy director is/are arranged as a separate component in the area of a mounting surface, or that the seal and/or the energy director is/are formed integrally with the housing in the area of a mounting surface. The mounting surface can be the surface used to support the pressure equalization device on the receiving housing of the electrochemical or electrical device. For instance, a circumferential protrusion can be used as an energy director. It can be used to melt in the connection area between the receiving housing and the housing to create a connection and/or seal in that way. It is conceivable that an adhesive bond is made, for instance by means of ultrasonic welding, laser welding or friction welding. It is also conceivable that the connection partners are joined by securing with a center-locating punch or by hot stamping. Furthermore, it is conceivable that an adhesive bond is also made between the connection partners.

In the context of the invention, the blade of the cutting element may be a linear or otherwise shaped blade. Furthermore, the blade of the cutting element can also form a point-shaped blade.

In the context of the invention, the diaphragm can be designed to be watertight or largely watertight; the diaphragm can in particular be designed as a sheet element, in particular as a plastic film. A polyester material used for the diaphragm, may for instance comprise a polyethylene terephthalate or a polycarbonate, or it may be made entirely of such a material.

The diaphragm is preferably shaped like a circular disc. This results in advantageous properties when the diaphragm is deformed.

The invention is explained in greater detail below based on exemplary embodiments shown in the drawings. In the figures,

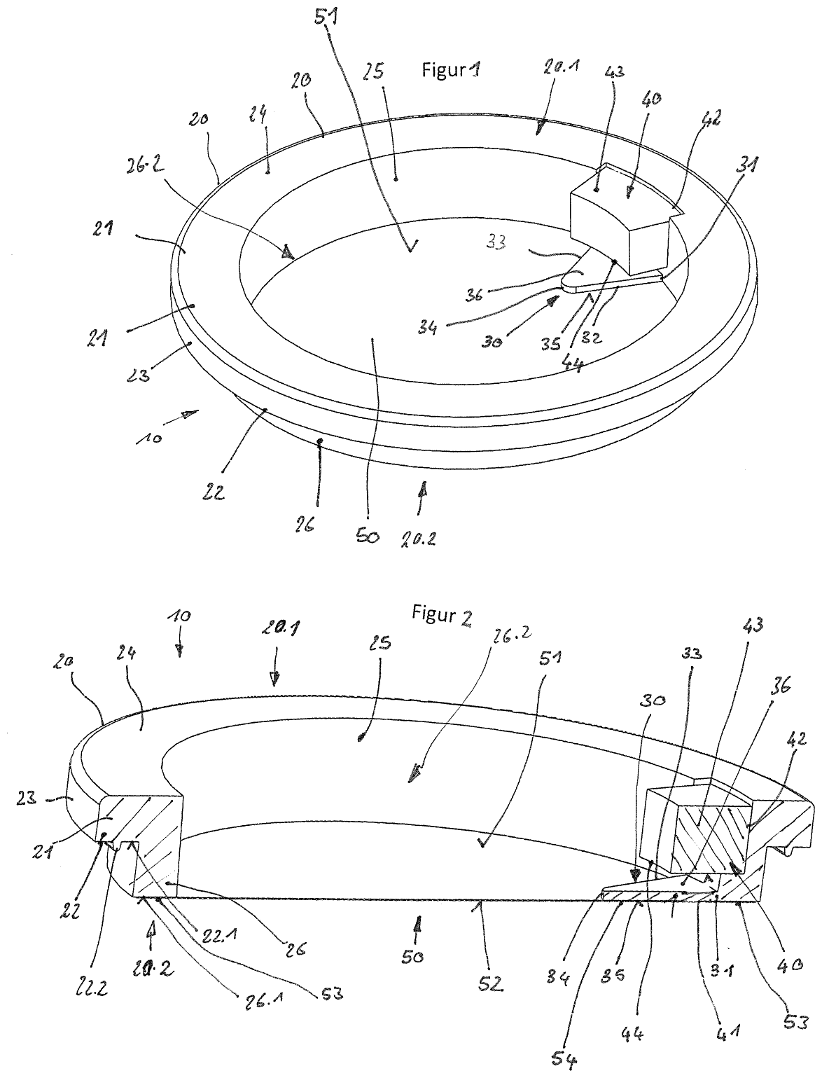

FIG. 1 shows a perspective view of a 1st variant of the embodiment of a pressure equalization device,

FIG. 2 shows a full section of the pressure equalization device of FIG. 1,

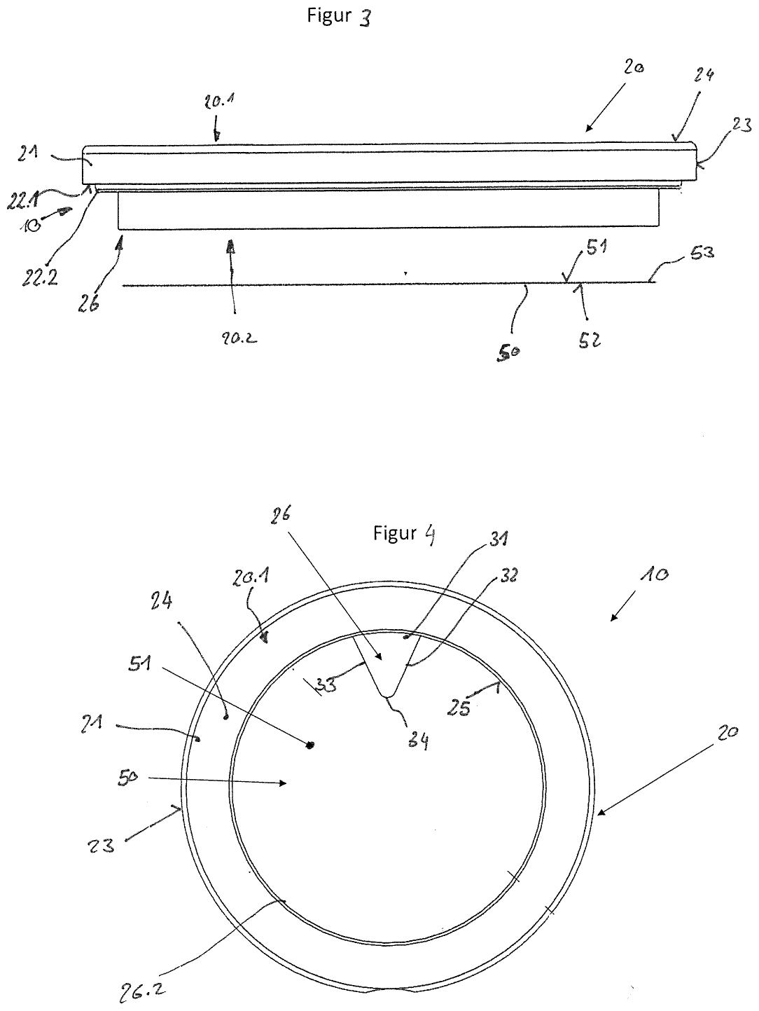

FIG. 3 shows a side view and a full section of a further design variant of a pressure equalization device,

FIG. 4 shows a top view of the pressure equalization device of FIG. 3,

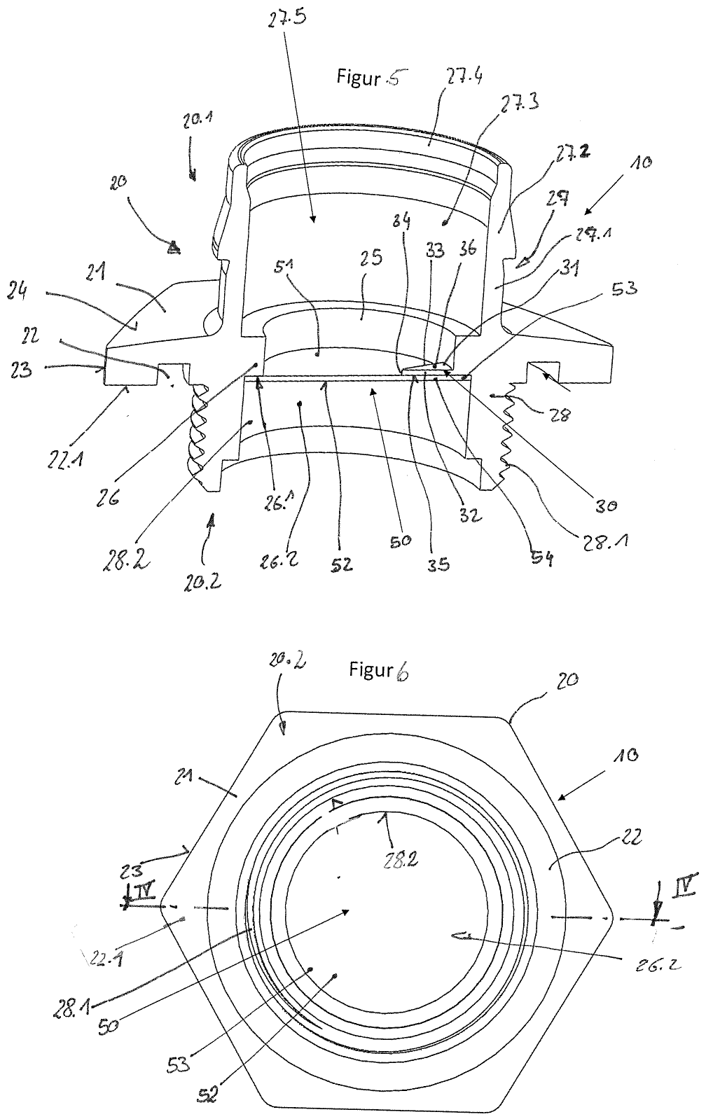

FIG. 5 shows a perspective view of a 3rd variant of the embodiment of a pressure equalization device in full section along the section marked IV-IV in FIG. 6, and

FIG. 6 shows a bottom view of the pressure equalization device of FIG. 5.

FIG. 1 shows perspective view of a pressure equalization device 10. This pressure equalization device 10 has a housing 20. The housing 20 forms an exterior 20.1 and an interior 20.2.

When the housing 20 is operationally assembled with a receiving housing, in particular an electrochemical or electrical device, for instance an accumulator housing, the interior 20.2 is assigned to the interior of the receiving housing. The exterior 20.1, on the other hand, faces away from the inside of the receiving housing and is assigned to the environment.

In the area of the exterior 20.1, the housing 20 forms a cover 21. In addition, a cover surface 24 is used to close the latter at the top. Opposite from the cover surface 24, the housing 20 has a sealing section 22 on the cover 21.

The sealing section 22 may be formed as an annular circumferential projection on the housing 20, and preferably projects radially beyond an exterior of the housing 20.

The sealing section 22, facing the interior 20.2, forms a mounting surface 22.1. Preferably, this mounting surface 22.1 is formed as an annular circumferentially closed surface, which further preferably extends in the radial direction. A seal can be provided circumferentially in the area of the mounting surface 22.1, which seal is molded on in the area of the sealing section 22 using a 2-component injection molding process, for instance, and projects in the direction of the interior 20.2.

In addition or as an alternative to the seal, an energy director 22.2 may also be provided protruding from the mounting surface 22.1, as shown in FIG. 2. The energy director 22.2 can be designed as circumferential bulge.

For a compact design, the cover surface 24 of the housing 20 transitions into an outer wall 23 of the cover 21, preferably via a rounding transition.

The housing 20 forms an inner panel 25 encompassing a gas passage opening 26.2.

A diaphragm 50 can be used to close the gas passage opening 26.2. The diaphragm 50 is designed as a sheet element and is preferably made of a gas-permeable or gas-tight plastic film. The diaphragm 50 is formed to be substantially watertight and is preferably tear resistant to a sufficient degree to prevent the accidental failure of the diaphragm 50 by exposure to water pressure from the exterior 20.1.

The diaphragm 50 has an outer face of the diaphragm 51 facing the exterior 20.1 of the housing 20. Opposite from the outer face of the diaphragm 51, the diaphragm 50 has an inner face of the diaphragm 52, which faces the interior 20.2. of the housing 20.

As can be seen from FIG. 2, the diaphragm 50 can have a circumferential mounting section 53, which in particular can be annular in shape. This mounting section 53 is used to connect the diaphragm 50 in a gas-tight manner to a connection section 26.1 of a diaphragm mount 26, preferably by an adhesive bond. In particular, the diaphragm 50 may be back-injected with the housing 20 using a plastic injection molding process.

The connection section 26.2 is formed as an annular circumferential surface 26.1 on the diaphragm mount 26. In particular, the connection section 26.1 extends around the gas passage opening 26.2 in an annular shape.

FIGS. 1 and 2 further show that a cutting element 30 is provided on the housing 20, which cutting element is preferably integrally connected to the housing 20. Particularly preferably, the cutting element 30 is integrally connected to the inner panel 25 of the housing 20.

As shown in the drawings, the cutting element 30 is connected to the housing 20 via a spring section 31. Furthermore, the entire cutting element 30 can also additionally be spring-elastic or form the spring section 31.

The cutting element 30 has a blade 34. The blade 34 can be point-shaped, linear, curved or formed in any other shape.

As shown in the drawings, the cutting element 30 can project from the housing 20, in particular from the inner panel 25, in the form of a tongue, in particular project radially inwards into the area of the gas passage opening 26.2.

As shown in FIGS. 1 and 2, the cutting element 30 may have rims 32, 33 in the circumferential direction of the wall 25, on opposite sides. Preferably, these two rims 32, 33 converge from the point of attachment to the housing 20 towards the free end of the cutting element 30. A convexly curved contour is arranged at the free end of the cutting element 30, which forms the blade 34, preferably with an arcuate blade 34. However, as mentioned above, the blade 34 can also have a different contour.

FIG. 2 shows that the cutting element 30 forms a contact section 35 on its end facing the interior 20.2 of the housing 20. This contact section 35 bears against the outer face of the diaphragm 51. Preferably, when the pressure equalization device 10 is depressurized, the contact section 35 rests on the outer face of the diaphragm 51. Particularly preferably, provision may be made for the contact section 35, at least sectionally, to be connected to the outer face 51 of the diaphragm by an adhesive bond.

FIG. 2 further shows that the underside of the contact section 35 forms a surface that transitions into the connection section 26.1 in a planar manner. Across this connection point, an adhesive bond can be established between the outer face of the diaphragm 51 and the cutting element 30 or the connection section 26.1.

The cutting element 30 forms a deflection piece 36 that faces the exterior 20.1 of the housing 20.

A travel limiter 40 may be provided at the housing 20. The travel limiter 40 may be formed as a separate component and may be connected to the housing 20 via a connection section 42. Further, provision may be made for a connection section 42 to be used to integrally connect the travel limiter 40 to the housing 20.

The travel limiter 40 has a stop 44, which is preferably kept spaced apart from the housing contour, preferably spaced apart from the inner panel 25, by a spacer 43.

The travel limiter 40 is spaced apart from the cutting element 30 in the direction toward the exterior 20.1 of the housing 20. An underside 41 of the travel limiter 40 may face the deflection piece 36 of the cutting element 30.

For assembly, the pressure equalization device 10 is inserted into an opening of a receiving housing of an electrical or electrochemical assembly. The mounting surface 22.1 covers the rim of this opening. Energy is introduced into the energy director 22.2 via a suitable energy generator, for instance a laser welder or an ultrasonic welder. The energy director then melts and bonds with the receiving housing in the area of the mounting surface 22.1. In this way, a circumferentially sealed connection is established between the housing 20 and the receiving housing.

During operation, the pressure in the receiving housing changes due to the operating conditions. If the pressure in the receiving housing increases, the diaphragm 50 bulges in the direction of the exterior 20.1. In the process, the cutting element 30 is deflected in a spring-elastic manner at its spring section 31 in the direction of the exterior 20.1. If the pressure in the receiving housing decreases, the diaphragm 50 bulges in the direction of the interior 20.2.

If an impermissibly high burst pressure now occurs in the receiving housing, the diaphragm 50 bulges in the direction of the exterior 20.1. The cutting element 30 is deflected again until its deflection piece 36 hits the stop 44 of the travel limiter 40. At this point, at the latest, the cutting element 30 offers a high resistance towards the diaphragm 50. This resistance causes the blade 34 to cut the diaphragm 50, which then ruptures. In this way, the internal pressure in the receiving housing can decrease via the gas passage opening 26.2.

Provision may also be made for the cutting element 30 and the spring section 31 to be designed in such a way that the cutting element 34 cuts the diaphragm 50 before the deflection piece 36 hits the stop 44. In that case, the travel limiter 40 forms a safety feature, which in any case ensures that the diaphragm 50 will be destroyed if an impermissibly high pressure is generated in the receiving housing.

FIGS. 3 and 4 show a further variant of a pressure equalization device 10. This pressure equalization device 10 is similar in design to the pressure equalization device 10 shown in FIGS. 1 and 2. To avoid repetition, reference can be made to the explanations above.

In contrast to the design variant according to FIGS. 1 and 2, however, the pressure equalization device 10 according to FIGS. 3 and 4 does not have a travel limiter 40. Accordingly, the cutting element 30 or the spring section 31 are designed in such a way that the cutting element 34 reliably destroys the diaphragm 50 in the event of an impermissible deformation of the diaphragm.

FIGS. 5 and 6 show a further design variant of a pressure equalization device 10. In principle, this pressure equalization device 10 is similar to the pressure equalization device 10 according to FIGS. 3 and 4, or according to FIGS. 1 and 2, which is why reference is made to the above explanations. Therefore, only the differences between the variants of the embodiment are explained below.

As FIG. 6 shows, the cover has a tool mount on its outer circumference to permit the pressure equalization device 10 to be mounted. In particular, the tool mount is designed as an external hexagon.

In the area of the interior 20.2 of the housing 20, the pressure equalization device 10 has a protruding mounting part 28. This mounting part 28 can be used to mount the pressure equalization device 10 in the opening of the receiving housing. Preferably, the mounting part 28 has a threaded section 28.1, which is preferably formed as a male thread. This male thread can be used to screw the housing 20 into a female thread of the receiving housing. The mounting part 28 may have a circumferential inner panel to provide a gas passage area that is connected to the gas passage opening 26.2 of the housing 20 in a gas-conveying manner.

A connector 27 can be integrally formed in the area of the exterior 20.1, as shown in FIG. 5. The connector 27 forms a discharge section 27.1 encompassing a gas guide 27.3. The gas guide 27.3 may connected to the gas passage opening 26.2 in a gas-conveying manner. At its free end, the connector 27 forms a connecting socket 27.2 with an outlet opening 27.4. A suitable discharge can be mounted in the area of the connection socket 27.2.

The drawings further illustrate that a circumferential sealing section 22, for instance having a circumferential groove, can be provided in the area of the mounting surface 22.1. A seal can be inserted into this circumferential groove.

It is also conceivable that a sealing element is molded onto the sealing section, in particular into the circumferential groove, in particular molded onto the housing 20 in a 2-component injection molding process or foamed into the groove.

As has been explained above, in the context of the invention, the housing 20 may be made of plastic, in particular it may be integrally formed as an injection-molded plastic part.

1-17. (canceled)

18: A pressure equalization device for equalizing an internal pressure in a battery housing, comprising:
a housing defining an interior and an exterior, the housing including at least one gas passage opening communicating the interior and the exterior, the housing including a diaphragm mount;
a gas-tight diaphragm mounted on the diaphragm mount and closing off the gas passage opening; and
a cutting element configured such that in an event of a deformation of the diaphragm the cutting element cuts the diaphragm at least at one location to establish a flow connection between the interior and the exterior through the gas passage opening, the cutting element including a spring section coupling the cutting element directly or indirectly to the housing such that in the event of the deformation of the diaphragm the cutting element is displaced at least partially.

19: The pressure equalization device of claim 18, wherein:
the cutting element includes a deflection piece bearing against the diaphragm in at least one operating position of the diaphragm.

20: The pressure equalization device of claim 19, wherein:
the deflection piece includes a surface bearing against the diaphragm when an equal ambient pressure is present in both the interior and the exterior of the housing.

21: The pressure equalization device of claim 19, wherein:
the deflection piece and/or the spring section are engaged with the diaphragm in a form-fitting manner.

22: The pressure equalization device of claim 18, wherein:
the cutting element is integrally connected to the housing.

23: The pressure equalization device of claim 18, wherein:
the housing includes a circumferential inner panel delimiting the gas passage opening; and
the cutting element protrudes from the circumferential inner panel in the form of a tongue projecting from the circumferential inner panel into the gas passage opening.

24: The pressure equalization device of claim 23, wherein:
the cutting element includes first and second rims on opposite sides of the cutting element, the rims laterally delimiting the cutting element, wherein the first and second rims converge towards each other in a direction from the circumferential inner panel towards a free end of the cutting element along at least part of a length of the cutting element.

25: The pressure equalization device of claim 18, wherein:
at least a portion of the cutting element forms a blade.

26: The pressure equalization device of claim 18, wherein:
the diaphragm mount of the housing includes a circumferential connection section;
the cutting element includes a contact section configured to contact the diaphragm, the contact section transitioning into the circumferential connection section in a planar manner; and
the diaphragm is mounted to the circumferential connection section by an adhesive bond.

27: The pressure equalization device of claim 18, wherein:
the diaphragm includes an outer face communicated with the exterior of the housing and an inner face communicated with the interior of the housing; and
the cutting element engages the outer face of the diaphragm when the diaphragm is in a non-pressurized position.

28: The pressure equalization device of claim 18, further comprising:
a travel limiter including a stop spaced from the cutting element in a direction towards the exterior of the housing, the travel limiter being configured such that the cutting element strikes against the stop when the diaphragm is deformed.

29: The pressure equalization device of claim 28, wherein:
the travel limiter includes a connection section integrally connected to the housing.

30: The pressure equalization device of claim 28, wherein:
the housing includes a circumferential inner panel delimiting the gas passage opening; and
the travel limiter includes a spacer holding the stop spaced apart from the circumferential inner panel.

31: The pressure equalization device of claim 18, wherein:
the housing includes a mounting surface for mounting the pressure equalization device on the battery housing, and a circumferential sealing section on the mounting surface.

32: The pressure equalization device of claim 31, wherein:
the circumferential sealing section includes a circumferential seal, the circumferential seal being a separate component from the mounting surface.

33: The pressure equalization device of claim 31, wherein:
the circumferential sealing section includes a circumferential energy director protrusion formed integrally on the mounting surface.

34: The pressure equalization device of claim 18, wherein:
the housing includes an integrally formed cover extending circumferentially around the gas passage opening and projecting radially outwards on the housing.

35: The pressure equalization device of claim 18, wherein:
the housing includes an integrally formed connector protruding towards the exterior of the housing, the connector being connected to the gas passage opening in a gas-conveying manner, the connector forming an outlet opening.

36: The pressure equalization device of claim 18, wherein:
the housing includes an integrally formed mounting part protruding towards the interior of the housing, the mounting part including a threaded section for connection of the pressure equalization device to the battery housing, the mounting part including an inner panel delimiting a gas passage communicated with the gas passage opening in a gas-conveying manner.
